(19) United States
(12) Patent Application Publication
(10) Pub. No.: US 2016/0018009 A1
(43) Pub. Date: Jan. 21, 2016

(54) PLUG VALVE WITH LINEAR FLOW CONTROL AND METHOD FOR DESIGNING THE SAME

(71) Applicant: HSU-NAN LIU, TAIPEI CITY (TW)

(72) Inventor: HSU-NAN LIU, TAIPEI CITY (TW)

(21) Appl. No.: 14/331,248

(22) Filed: Jul. 15, 2014

(51) Int. Cl. F16K 5/04; G06F 17/50; F16K 5/10

(52) U.S. Cl. CPC F16K 5/0414; F16K 5/103; G06F 17/50

(57) ABSTRACT

A plug valve with linear flow control and a method for designing the plug valve are disclosed. The plug valve has a valve body and a plug being rotatably inserted into the valve body. The valve body has an air inlet communicated to a through hole formed on the plug. The plug has a flow-regulating slot communicated with an air outlet of the valve body. When the plug rotates, the air outlet of the valve body successively overlaps the flow-regulating slot at a starting position, an adjusting position and an ending position defined along the flow-regulating slot. Where the air outlet of the valve body overlaps the flow-regulating slot at the positions is defined as a venting area. The venting area changes linearly from the starting position, the adjusting position to the ending position. The plug valve therefore provides flow control that is relatively linear.

### BACKGROUND OF THE INVENTION

1. Technical Field

The present invention relates to valves, and more particularly, a plug valve with linear flow control and a method for designing the same, wherein the plug valve has its plug formed with a linearly-changing flow-regulating slot, so as to provide linear flow control.

2. Description of Related Art

Flow valves are conventionally used for flow control in gas stoves. As an example, the subject matter of Taiwan Patent No. M453067 titled “Adjustable Solenoid Gas Flow Valve” comprises a valve that includes an inlet and an outlet, and also has a first and a second gas channel communicated to the inlet and the outlet. It further has a first shield for closing or opening the first gas channel and a second shield for closing or opening the second gas channel, thereby providing gas flow control.

However, the control provided by the known gas flow valve is non-linear and may cause the regulated gas flow, and in turn the flame, to increase or decrease sharply. In other words, a user cannot use the prior-art device to adjust gas flow and in turn flame at will.

### SUMMARY OF THE INVENTION

The present invention provides method for designing a plug valve with linear flow control, the plug valve having a valve body and a plug being rotatably inserted into the valve body, wherein the valve body has an air inlet communicated to a through hole formed on the plug, and the plug has a flow-regulating slot being communicated to an air outlet of the valve body, the method comprising:
defining a starting position and an ending position for the flow-regulating slot of the plug, and at least one adjusting position between the starting position and the ending position, so that when the plug rotates, the air outlet of the valve body overlaps the flow-regulating slot at the starting position, the adjusting position and the ending position successively, wherein where the air outlet of the valve body overlaps the flow-regulating slot at the starting position, the adjusting position and the ending position of the flow-regulating slot is defined as a venting area, and the venting area linearly changes as it successively corresponds to the starting position, the adjusting position and the ending position.

Further, intervals between adjacent said starting, adjusting and ending positions are equivalent, and the venting area changes in arithmetic progression from the starting position, the adjusting position to the ending position.

Further, the venting area changes based on an area where it corresponds to the starting position in arithmetic progression with a constant increment or decrement in area.

Further, the increment or decrement is substantially a 10-percent increment or decrement in area.

Further, the increment or decrement stays below a tolerance of 20 percent.

The present invention also provides a plug valve with linear flow control designed and made using the foregoing method, the plug valve comprising:

A valve body, having an air inlet and an air outlet; and a plug, being inserted into the valve body and rotatably connected to the valve body, the plug having a through hole communicated to the air inlet, and having a flow-regulating slot being communicated to the air outlet, wherein the flow-regulating slot of the plug has a starting position, an ending position and at least one adjusting position located therebetween, so that when the plug rotates, the air outlet of the valve body is successively aligned with the starting position, the adjusting position and the ending position of the flow-regulating slot, in which where the air outlet of the valve body overlaps the flow-regulating slot at the starting position, the adjusting position and the ending position is defined as a venting area, and the venting area changes linearly from the starting position, the adjusting position to the ending position.

Further, intervals between adjacent said starting, adjusting and ending positions are equivalent, and the venting area changes in arithmetic progression from the starting position, the adjusting position to the ending position.

Further, a rotation range of the flow-regulating slot of the plug from the starting position to the ending position is between 45 degrees and 180 degrees.

Further, the plug has a rotation path, along which the starting position, the adjusting position and the ending position of the flow-regulating slot are distributed, the flow-regulating slot is formed as a tapered slot defined by two lines that are oppositely tangential to two circles that are centered at the starting position and the ending position, respectively, and outer peripheral parts of the two circles.

Further, the plug has a rotation path, and the flow-regulating slot is formed as a rectangular hole that has an axis including an included angle with the rotation path.

The present invention has the following advantage:

When applied to a gas stove or other flow-regulating devices, the disclosed plug valve provides flow control that is relatively linear.

### BRIEF DESCRIPTION OF THE DRAWINGS

FIG. 1 is a cross-sectional view of a plug valve according to one embodiment of the present invention.

FIG. 2 is a perspective view of a plug in the plug valve.

FIG. 3 is a schematic drawing according to one embodiment of the present invention illustrating linear change of the overlapping area, or the venting area, between the air outlet of the valve body and the flow-regulating slot of the plug.

FIG. 4 is a schematic drawing according to another embodiment of the present invention illustrating linear change of the venting area between the air outlet of the valve body and the flow-regulating slot of the plug.

FIG. 5 is a schematic drawing according to still another embodiment of the present invention illustrating linear change of the venting area between the air outlet of the valve body and the flow-regulating slot of the plug.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement. structure, features and effects of the subject matter of the present invention.

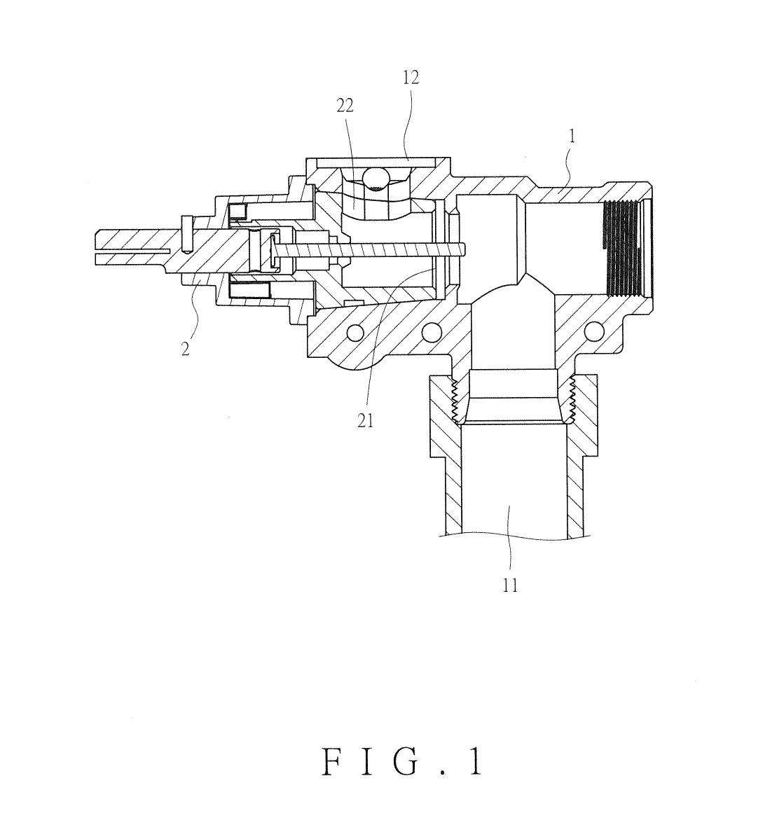

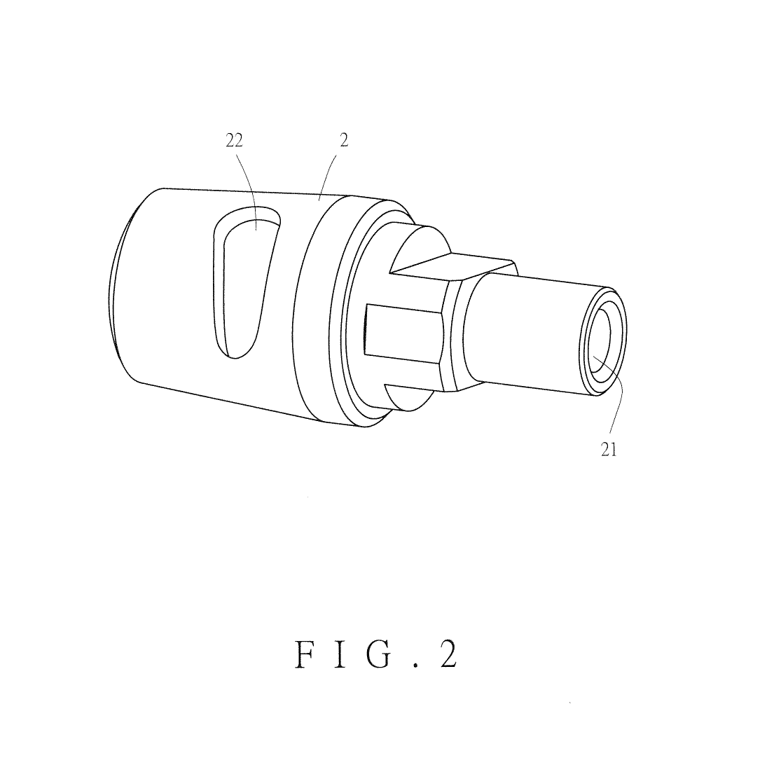

Referring to FIG. 1 and FIG. 2, according to one embodiment of the present invention, a plug valve comprises a valve body (1) and a plug (2).

The valve body (1) includes an air inlet (11) and an air outlet (12). The plug (2) is inserted into the valve body (1) and is rotatably connected to the valve body (1). Therein, the plug (2) has a rotation range of 180 degrees. In other embodiments, the rotation range may be greater or smaller than 180 degrees as needed. For example, when the disclosed plug valve is applied to a gas stove, the rotation range of the plug (2) may be set as between 45 degrees and 180 degrees. The plug (2) has a through hole (21) that is communicated to the air inlet (11), and has a flow-regulating slot (22) that is communicated to the air outlet (12).

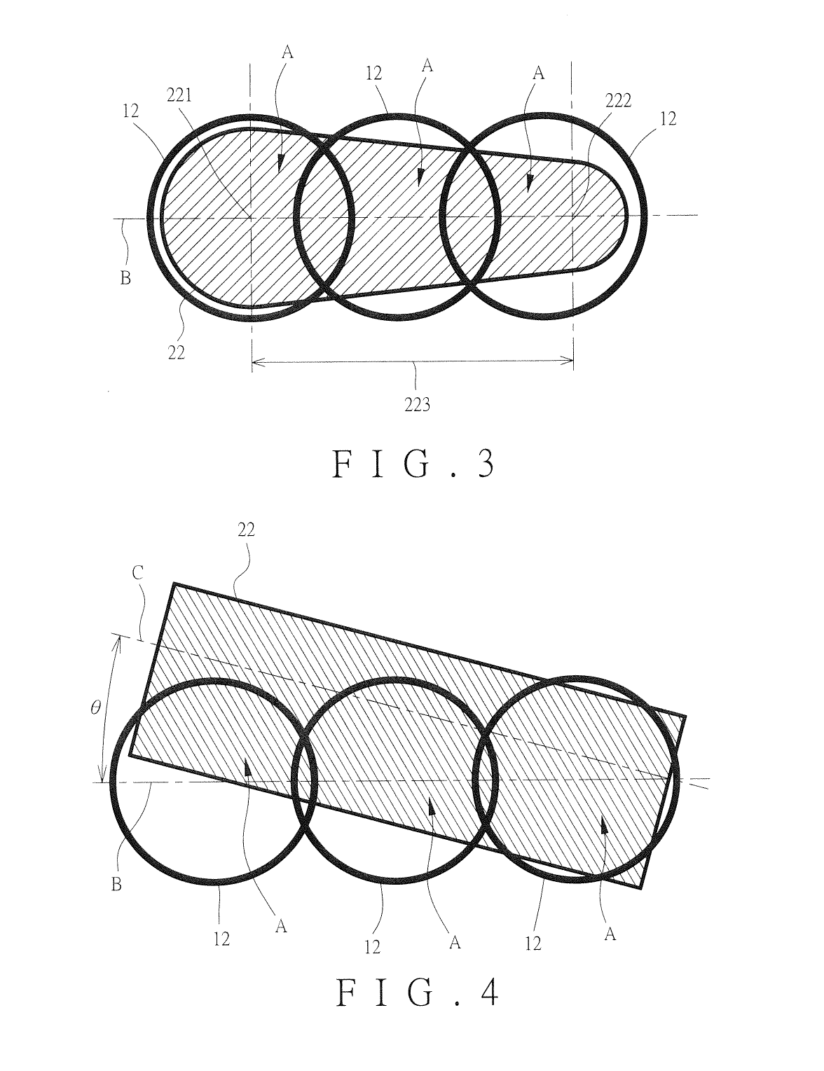

As shown in FIG. 3, according to one embodiment of the present invention, a method for designing the plug valve comprises the steps as described below.

A starting position (221) and an ending position (222) are defined in the flow-regulating slot (22) of the plug (2). At least one adjusting position (223) is defined between the starting position (221) and the ending position (222). As the plug (2) rotates, the air outlet (12) of the valve body (1) overlaps the flow-regulating slot (22) at the starting position (221), the adjusting position (223) and the ending position (222) successively. Where the air outlet (12) of the valve body (1) overlaps the flow-regulating slot (22) at the starting position (221), the adjusting position (223) and the ending position (222) is defined as a venting area (A), and the venting area (A) has its size linearly changing as it successively corresponds to the starting position (221), the adjusting position (223) and the ending position (222). The linear change of the venting area (A) allows the disclosed plug valve when being applied to a gas stove or other flow-regulating devices to provide linear regulation to the flow of gas or other working fluids, thereby preventing the regulated output of gas or other working fluids from increasing or decreasing sharply.

It is to be further explained that, all of intervals between the adjacent starting position (221), the adjusting position (223) and ending position (222) are equivalent, and the venting area (A) changes in arithmetic progression from the starting position (221), the adjusting position (223) to the ending position (222). Therein, the venting area (A) may change in arithmetic progression based on its area corresponding to the starting position (221) with a constant increment or decrement. The increment or decrement may be substantially 10 percent change in area, and the increment or decrement allows a tolerance below 20 percent.

Preferably, the plug (2) has a rotation direction defined as a rotation path (B). The starting position (221) and the ending position (222) of the flow-regulating slot (22) are on the rotation path (B), and the at least one adjusting position (223) is distributed along the rotation path (B). The flow-regulating slot (22) is formed as a tapered slot defined by two lines that are oppositely tangential to two circles that are centered at the starting position (221) and the ending position (222), respectively, and outer peripheral parts of the two circles. This allows the venting area (A) where the air outlet (12) of the valve body (1) and the flow-regulating slot (22) of the plug (2) overlap to continuously change from the starting position (221 the adjusting position (223) to the ending position (222).

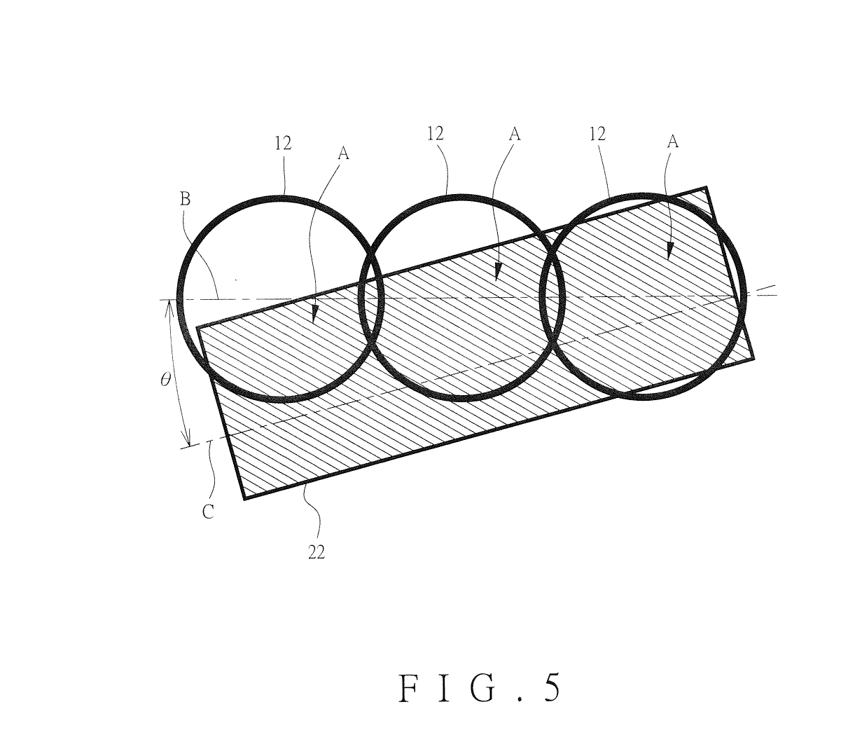

Referring to FIG. 4 and FIG. 5, in another embodiment of the present invention, the flow-regulating slot (22) of the plug (2) is formed differently. While the rotation direction of the plug (2) is similarly defined as the rotation path (B), the flow-regulating slot (22) is a rectangular hole. The rectangular hole has an axis (C) that includes an included angle (0) with the rotation path (B). Thereby, the venting area (A) where the air outlet (12) of the valve body (1) and the flow-regulating slot (22) of the plug (2) overlap also changes linearly from the starting position (221), the adjusting position (223) to the ending position (222).

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for designing a plug valve with linear flow control, the plug valve having a valve body and a plug being rotatably inserted into the valve body, wherein the valve body has an air inlet communicated to a through hole formed on the plug, and the plug has a flow-regulating slot being communicated to an air outlet of the valve body, the method comprising:
defining a starting position and an ending position for the flow-regulating slot of the plug, and at least one adjusting position between the starting position and the ending position, so that when the plug rotates, the air outlet of the valve body overlaps the flow-regulating slot at the starting position, the adjusting position and the ending position successively, wherein where the air outlet of the valve body overlaps the flow-regulating slot at the starting position, the adjusting position and the ending position of the flow-regulating slot is defined as a venting area, and the venting area linearly changes as it successively corresponds to the starting position, the adjusting position and the ending position.

2. The method of claim 1, wherein intervals between adjacent said starting, adjusting and ending positions are equivalent, and the venting area changes in arithmetic progression from the starting position, the adjusting position to the ending position.

3. The method of claim 2, wherein the venting area changes based on an area where it corresponds to the starting position in arithmetic progression with a constant increment or decrement in area.

4. The method of claim 3, wherein the increment or decrement is substantially a 10-percent increment or decrement in area.

5. The method of claim 3, wherein the increment or decrement stays below a tolerance of 20 percent.

6. A plug valve with linear flow control, comprising:
a valve body, having an air inlet and an air outlet; and
a plug, being inserted into the valve body and rotatably connected to the valve body, the plug having a through hole communicated to the air inlet, and having a flow-regulating slot being communicated to the air outlet, wherein the flow-regulating slot of the plug has a starting position, an ending position and at least one adjusting position located therebetween, so that when the plug rotates, the air outlet of the valve body is successively aligned with the starting position, the adjusting position and the ending position of the flow-regulating slot, in which where the air outlet of the valve body overlaps the flow-regulating slot at the starting position, the adjusting position and the ending position is defined as a venting area, and the venting area changes linearly from the starting position, the adjusting position to the ending position.

7. The plug valve of claim 6, wherein intervals between adjacent said starting, adjusting and ending positions are equivalent, and the venting area changes in arithmetic progression from the starting position, the adjusting position to the ending position.

8. The plug valve of claim 6, wherein a rotation range of the flow-regulating slot of the plug from the starting position to the ending position is between 45 degrees and 180 degrees.

9. The plug valve of claim 6, wherein the plug has a rotation path, along which the starting position, the adjusting position and the ending position of the flow-regulating slot are distributed, the flow-regulating slot is formed as a tapered slot defined by two lines that are oppositely tangential to two circles that are centered at the starting position and the ending position, respectively, and outer peripheral parts of the two circles.

10. The plug valve of claim 6, wherein the plug has a rotation path, and the flow-regulating slot is formed as a rectangular hole that has an axis including an included angle with the rotation path.
